(19) United States
(12) Patent Application Publication
(10) Pub. No.: US 2006/0155887 A1
(43) Pub. Date: Jul. 13, 2006

(54) Enhanced multi-access data port

(76) Inventors: Yun Shon Low, Richmond (CA); Raymond Chow, Richmond (CA)

Correspondence Address: EPSON RESEARCH AND DEVELOPMENT INC;INTELLECTUAL PROPERTY DEPT, 150 RIVER OAKS PARKWAY, SUITE 225, SAN JOSE, CA, 95134, US

(21) Appl. No.: 11/033,744

(22) Filed: Jan. 12, 2005

(51) Int. Cl. G06F 3/00

(52) U.S. Cl. 710/5

(57) ABSTRACT

A method and system provide for transmitting data between a host and a device external to the host. The data is transmitted across an external bus having a width that is less than a native bus width of the host. The method includes receiving a first read/write access, accessing a register addressed according to an address signal received during the first read/write access, receiving subsequent read/write accesses of the same type as the first read/write access, and accessing the register for the subsequent read/write accesses regardless of the address signal received during the subsequent read/write accesses of the same type as the first read/write access. The read/write access is one of a read type access or a write type access.

### BACKGROUND OF THE INVENTION

1. Field of the Invention

The present invention relates generally to data communication between a host central processing unit (CPU) and a client device external to the host CPU. More specifically, the invention relates to a method and system for communicating over an external bus with a host CPU having a higher native bus width than the external bus.

2. Description of the Related Art

In typical embedded systems, it is common for CPU hosts to program large sets of registers for module initialization or writing large blocks of data to an external device's register port, e.g., via a first-in, first-out buffer (FIFO). However, it is also fairly common for CPU hosts to have internally wider native data bus in comparison to the external data bus of the external device.

Generally speaking, the CPU host will contain a memory management unit (MMU) that can handle the movement of data from the internal processor and the external device. In this case, the MMU formats the data and sends it out through the external bus according to the bus width of the attached external device. It is common for MMUs to include a bursting mode that automatically increments the address after each n-bit segment is transmitted. For example, if the CPU native bus width is 32 bits and it is sending data over an 8-bit external bus, the MMU would receive the data as a 32-bit word and break it up into four 8-bit bytes. After each 8-bit byte is transmitted, the address is incremented automatically.

FIG. 1A shows a transaction diagram 10 for one example of common transaction between a CPU host 32-bit data write to a memory-mapped 8-bit external device. Transaction diagram 10 shows bus-clock 12, address line 14, chip-select signal 18, and read/write data bus traffic 20. The data is broken down into four 8-bit burst data cycles, usually by the MMU, with the address incremented accordingly, as shown by address line 14 of FIG. 1. In the example shown, the Chip Select signal is driven HIGH between cycles. Turn-around time 16 is the time required to increment the address pointer and cycle-to-cycle overhead. As shown in transaction diagram 30 of FIG. 1B, it is also possible to provide the 32-bit burst of four 8-bit burst data cycles where the Chip Select 32 is driven LOW between cycles. In this case, the turn-around time between cycles, not shown in FIG. 1B, would be typically shorter than the example shown in FIG. 1A.

A deficiency of this system is that it does not permit a host CPU to write to a single memory mapped address that is narrower than its native bit size without manually, in software, breaking apart the data into smaller segments and sending each segment in series. The MMU could be leveraged to perform the segmentation of the native word length and send data to a single register by mapping the register to multiple consecutive addresses within the device. However, this is undesirable because it requires additional address space, which is limited. For example, if the address bus is 8-bits wide, there is only 256 addresses available. It would therefore be desirable to provide the capability to send and receive data to and from a single register without using a plurality of addresses.

The host CPU cannot transfer the data to a single FIFO port using instruction calls that operate at the native width (e.g., 32 bits) of the internal bus and take advantage of the MMU's burst transfer capability. Therefore, for the example shown in FIGS. 1A and 1B, only the first cycle passing data to address 0300 is valid. Because the address is automatically incremented by the MMU, subsequent data bursts are not directed to the target location.

As a result of the problem described above, the CPU must instead revert to handling the data using 8-bit instruction calls to write to 8 bit mapped address, i.e., load 8 bit data, store 8 bit data, load 8 bit data, etc., as shown in the transaction diagram of FIG. 1C. In this case, each 8-bit segment of data is passed with the address set to the desired destination address, as shown by address line 42. Because the CPU cannot execute a load 32-bit, store 32-bit series of instructions, the turn-around time 16 is increased due to the increased number of instruction cycles between transfers.

Because the CPU must execute more instructions for transferring data, the overall host CPU performance suffers. In addition, the program size is increased, requiring more program memory (or reduced capability). Finally, the overall throughput between the host CPU and the device suffers due to the increased latency time between data cycles.

### SUMMARY OF THE INVENTION

Broadly speaking, the present invention overcomes the deficiencies noted above by providing a method and apparatus in which the behavior of the client device's bus cycle operation is modified.

It should be appreciated that the present invention can be implemented in numerous ways, including as a process, an apparatus, a system, a device, or a method. Several inventive embodiments of the present invention are described below.

In one embodiment, a method is provided for transmitting data between a host and a device external to the host. The data is transmitted across an external bus having a width that is less than a native bus width of the host. The method includes receiving a first read/write access, accessing a register addressed according to an address signal received during the first read/write access, receiving subsequent read/write accesses of the same type as the first read/write access, and accessing the register for the subsequent read/write accesses regardless of the address signal received during the subsequent read/write accesses of the same type as the first read/write access. The read/write access is one of a read type access or a write type access.

In another embodiment, multi-access data port logic is provided for transmitting and receiving data from a host CPU across an external bus having a width that is less than a native bus width of the host. The multi-access data port logic receives a first read/write access, accesses a register addressed according to an address signal received during the first read/write access, receives subsequent read/write accesses of the same type as the first read/write access, and accesses the register for the subsequent read/write accesses regardless of the address signal received during the subsequent read/write accesses of the same type as the first read/write access. The read/write access is one of a read type access or a write type access.

In yet another embodiment, a host interface for a device external to and in communication with a host CPU, comprises multi-access data port logic for transmitting and receiving data from a host CPU across an external bus having a width that is less than a native bus width of the host. The multi-access data port logic causes the host interface to receive a first read/write access, access a register addressed according to an address signal received during the first read/write access, receive subsequent read/write accesses of the same type as the first read/write access, and access the register for the subsequent read/write accesses regardless of the address signal received during the subsequent read/write accesses of the same type as the first read/write access. The read/write access is one of a read type access or a write type access.

The advantages of the present invention will become apparent from the following detailed description, taken in conjunction with the accompanying drawings, illustrating by way of example the principles of the invention.

### BRIEF DESCRIPTION OF THE DRAWINGS

The present invention will be readily understood by the following detailed description in conjunction with the accompanying drawings, wherein like reference numerals designate like structural elements.

FIGS. 1A, 1B, and 1C show exemplary transaction diagrams illustrating deficiencies of prior art approaches to data transfer.

FIG. 2 shows an exemplary 32-bit host CPU interfacing with an 8-bit device.

FIG. 3 shows a simplified block diagram of an exemplary enhanced multi-access FIFO port.

FIG. 4 shows a transaction diagram for an operation example for the enhanced multi-access FIFO port of FIG. 3.

FIG. 5 shows an exemplary state machine for the enhanced multi-access FIFO port of FIG. 3.

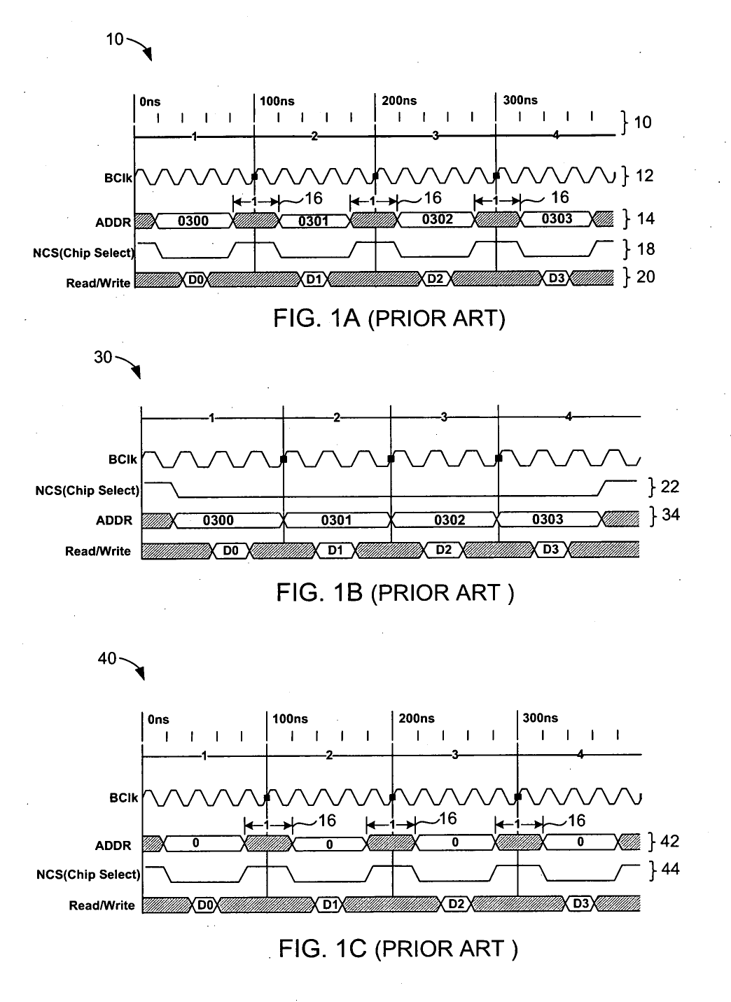

### DETAILED DESCRIPTION OF THE PREFERRED EMBODIMENTS

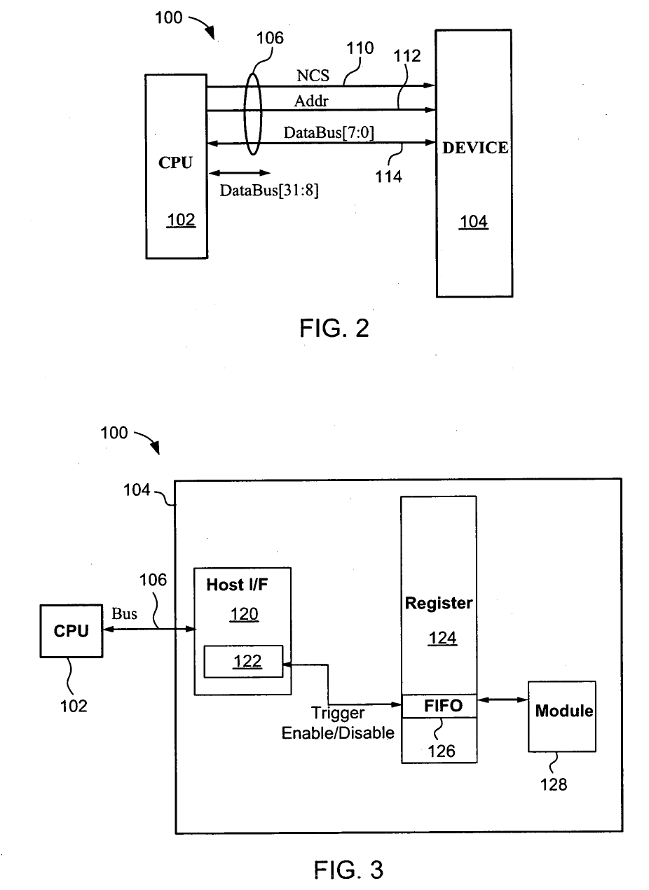

FIG. 2 shows an exemplary apparatus 100 incorporating an embedded host central processor unit (CPU) 102 in communication with an external device 104. Host CPU 102 has a 32-bit native data bus. However, external device 104 communicates over external bus 106, which includes a channel select signal line 110, an address signal 112, and an 8-bit data bus 114. External device 104 is external to CPU 104 but may or may not be external to apparatus 100.

Apparatus 100 may be any type of device having an embedded processor. Examples include cell phones, PDAs, digital cameras, recorders, video devices, computer peripherals, multimedia devices, etc. It should be noted that apparatus 100 might also be a component of a larger system rather than a stand-alone device. For example, apparatus 100 may be a user interface or other component of a machine such as office equipment, industrial equipment, or transportation equipment, such as a vehicle, e.g., automotive, aerospace, etc.

Host CPU 102 may provide data to external device 104 for any number of reasons. For example, external device 104 may be a display module or other output device to provide information or other media to a user. One example might be where external device 104 is a display module for a cell phone or other device. In such circumstances and many others, it is common for host CPU to program large sets of registers for module initialization or for writing large blocks of data to the external device's register port, e.g., via a first-in, first-out data buffer (FIFO).

FIG. 3 shows a simplified block diagram with some details of external device 104. CPU communicates over external bus 106 with host interface 120 of external device 104. Host interface 120 includes multi-access data port logic 122 implementing multi-access data port functionality to host interface 120. Register block 124 includes a plurality of registers addressable by host interface 120. FIFO 126 is a register in register block 124. FIFO 126 is as many bits wide as bus 106. For example, if bus 106 is 8 bits wide, then FIFO 126 is 8 bits wide to accommodate data received from bus 106. FIFO may be any number of layers deep. If FIFO 126 were receiving a 32 bits of data 8 bits at a time, FIFO 126 may be designed to be 4 levels deep, so that it can store the 32 bits of data. The FIFO would be designed according to the amount of data it is expected to store, which depends upon the application.

Module 128 may be any module in external device 104 requiring data from FIFO 126. For example, module 128 may be a memory card controller or a display controller. For example, if Apparatus 100 was a cell phone and Host CPU 102 wanted to display information on a display screen, it would transmit the data to external device 104 which may be a display controller module. The data would be received by host interface 120 which would direct the data to FIFO 126. For example, if module 128 was a display interface, it would receive the data from FIFO 126 and pass it to a display unit, such as an LCD screen (not shown).

According to one embodiment, a Chip Select signal is asserted for each write to a particular register. So long as the Chip Select signal is asserted and the read/write mode is maintained, the data port logic 122 ignores any address change after receiving the first address in the series of data bursts. Upon de-asserting the Chip Select signal, or upon switching from a read to a write operation, or from a write to a read operation, the address signal is read.

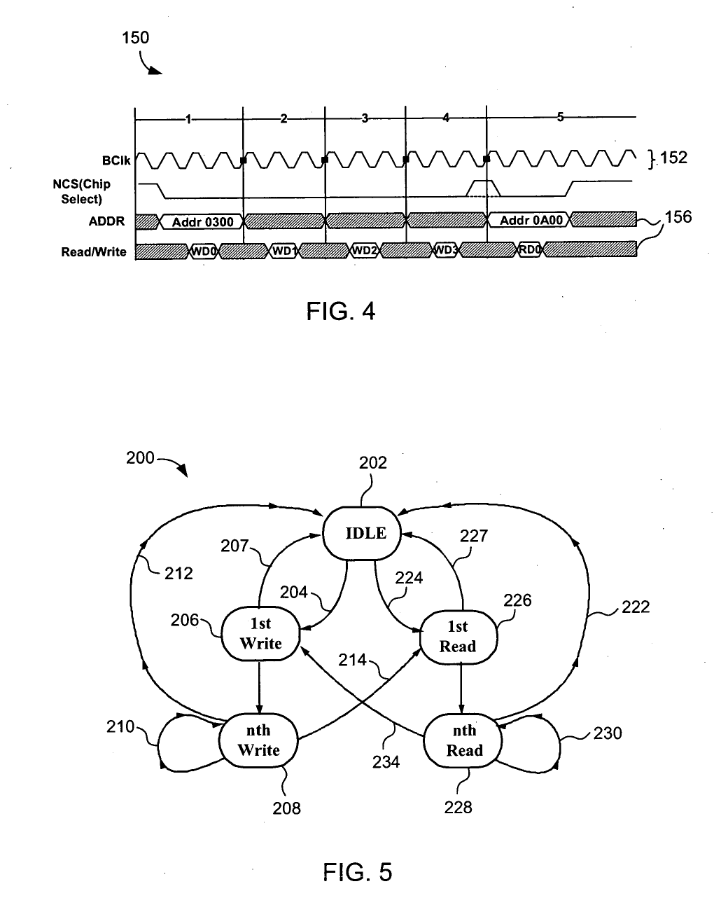

FIG. 4 shows transaction diagram 150 describing an exemplary 32 bit write access followed by an 8-bit read from the perspective of the external device. In this case, the Chip Select signal 152 is driven LOW and the first cycle bursts 8 bits in time period 1, with address signal 156 determining the register that will receive the first cycle. After the first cycle, the address signal 156 is ignored (represented in FIG. 4 by shading address line 156 after the first cycle). Although the MMU of the Host CPU will automatically increment the address signal, the external device ignores the address signal after the first cycle so long as the Chip Select signal 154 is maintained LOW. Therefore, the second, third, and fourth cycles will be received at the same location as the first cycle.

In the exemplary transaction shown in FIG. 4, after the 32 bits are written, an 8-bit read is performed. This may be for example, a status check implemented by a single 8-bit read. The Chip Select signal 152 will generally be driven HIGH between the read and write accesses by the host CPU. However, if the Chip Select signal is software controllable, it may be maintained LOW since the address signal 156 is received upon changing from a write access to a read access or vice versa.

The various states are shown by state machine diagram 200 shown in FIG. 5. The system starts in idle state 202. The state transfers. over line 204 upon a first segment of data being written to the external device. The first write state 206 causes the data to be stored in the register matching the address received during the first write. If the Chip Select signal is driven HIGH, then the state returns to idle along line 207. However, if subsequent writes are written to the external device and the Chip Select signal is maintained LOW, then the state is placed into nth write state 208 and data is received in the same address as the first write was received. Thus, for nth writes, the address signal is ignored. Any number of writes may be written to this same address as indicated by line 210 wherein the status remains at nth write state 208. If the Chip Select signal is driven HIGH, then the state returns to idle along line 212.

Likewise, upon a first read operation, the state transfers from idle to first read state 226 along line 224. The first read state 226 causes data to be read from the register matching the address received during the first read. If the Chip Select signal is driven HIGH, then the state returns to idle along line 227. However, if subsequent reads are read from the external device and the Chip Select signal is maintained LOW, then the state is placed into an nth read state 228 and data is read from the same address as the first read. Further subsequent reads return to the nth read state 228 along line 230. If the Chip Select signal is driven HIGH, then the state returns to idle along line 222.

As mentioned previously, if the host CPU has software control over the Chip Select signal, it can maintain the Chip Select signal LOW when switching between read and write operations. In this case, lines 214 and 234 can be used to go directly from nth write state 208 to the first read state 226 or from the nth read state 228 to the first write state 206, without passing through the idle state 202.

Several advantages are realized by implementing this method of register access on a slave/target device: First, no changes to the host CPU or external hardware are required making it simple to implement in any typical CPU system. In addition, the CPU performance improves because the CPU host can burst transfer data to the FIFO port by making use of native internal instructions to transfer data at the native bit width. The size of the program or firmware can be reduced (or more features added) because it takes fewer instructions to transfer the same amount of data (as compared to issuing several instructions of smaller data size). The CPU instruction overhead is reduced because fewer instructions are needed to make to transfer the data. The data cycles are back to back and optimized. The length of the burst transfer is not limited to the addressable range of the device. For example, an 8-bit addressable device can receive more than 256 bytes of data in burst mode. The system does not affect existing address space, i.e., it only requires one address location. Finally, the system is compatible with existing coding methodology for FIFO servicing because once the FIFO transfer is started, even if the thread is pre-empted, the CPU is interrupted, or the registers are polled to monitor status bits, the FIFO transfer is deactivated by a register read which is common to verify an interrupt status register or FIFO status port to act on a condition.

Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims.

1. A method for transmitting data between a host and a device external to the host, across an external bus having a width that is less than a native bus width of the host, the method comprising:
receiving a first read/write access, the read/write access being one of a read type access or a write type access;
accessing a register addressed according to an address signal received during the first read/write access;
receiving subsequent read/write accesses of the same type as the first read/write access; and
accessing the register for the subsequent read/write accesses regardless of the address signal received during the subsequent read/write accesses of the same type as the first read/write access.

2. The method of claim 1, wherein the register is a FIFO.

3. The method of claim 1, wherein a Chip Select signal maintained in a first state during the first read/write access and the subsequent read/write accesses, the Chip Select signal being returned to a second state upon completion of a last subsequent read/write access.

4. The method of claim 3 wherein access is maintained to the register so long as the Chip Select signal is maintained in the first state and the type of access is unchanged.

5. The method of claim 3 wherein for a first new read/write access after the Chip Select signal is returned to the second state, a new register is accessed according to a new address signal received during the first new read/write access.

6. The method of claim 3 wherein for a first new read/write access of a different type of the first read/write access, a new register is accessed according to a new address signal received during the first new read/write access.

7. The method of claim 3 wherein the first state is a logical LOW and the second state is a logical HIGH.

8. The method of claim 1 wherein the external bus is N bits wide and the native bus width of the host is NX bits wide, X being a positive integer greater than 1.

9. The method of claim 8 wherein, for a write access to the external device, a host memory management unit (MMU) divides an NX-bit word of data into X bytes each having N bits, the MMU bursting the NX bits of data to the external device in a write access comprising the first read/write access and N-1 number of the subsequent read/write accesses.

10. The method of claim 9 wherein the address signal is incremented after the first read/write access and each of the subsequent read/write accesses.

11. Multi-access data port logic for transmitting and receiving data from a host CPU across an external bus having a width that is less than a native bus width of the host, wherein the multi-access data port logic is configured for:
receiving a first read/write access, the read/write access being one of a read type access or a write type access;
accessing a register addressed according to an address signal received during the first read/write access;
receiving subsequent read/write accesses of the same type as the first read/write access; and
accessing the register for the subsequent read/write accesses regardless of the address signal received during the subsequent read/write accesses of the same type as the first read/write access.

12. The multi-access data port logic of claim 11 wherein the register is a FIFO.

13. The multi-access data port logic of claim 11 wherein a Chip Select signal is maintained in a first state during the first read/write access and the subsequent read/write accesses, the Chip Select signal being returned to a second state upon completion of a last subsequent read/write access.

14. The multi-access data port logic of claim 13 wherein access is maintained to the register so long as the Chip Select signal is maintained in the first state and the type of access is unchanged.

15. The multi-access data port logic of claim 13 wherein for a first new read/write access after the Chip Select signal is returned to the second state, a new register is accessed according to a new address signal received during the first new read/write access.

16. The multi-access data port logic of claim 13 wherein for a first new read/write access of a different type of the first read/write access, a new register is accessed according to a new address signal received during the first new read/write access.

17. A host interface for a device external to and in communication with a host CPU, the host interface comprising multi-access data port logic for transmitting and receiving data from a host CPU across an external bus having a width that is less than a native bus width of the host, the multi-access data port logic causing the host interface to:
receive a first read/write access, the read/write access being one of a read type access or a write type access;
access a register addressed according to an address signal received during the first read/write access;
receive subsequent read/write accesses of the same type as the first read/write access; and
access the register for the subsequent read/write accesses regardless of the address signal received during the subsequent read/write accesses of the same type as the first read/write access.

18. The host interface of claim 16, wherein the register is a FIFO.

19. The host interface of claim 16, wherein a Chip Select signal is maintained in a first state during the first read/write access and the subsequent read/write accesses, the Chip Select signal being returned to a second state upon completion of a last subsequent read/write access.

20. The multi-access data port logic of claim 19 wherein access is maintained to the register so long as the Chip Select signal is maintained in the first state and the type of access is unchanged.
